(19) United States
(12) Patent Application Publication
(10) Pub. No.: US 2020/0274420 A1
(43) Pub. Date: Aug. 27, 2020

(54) POWER FEED JOINT STRUCTURE OF POWER CONTROL UNIT

(71) Applicant: HONDA MOTOR CO., LTD., Tokyo (JP)

(72) Inventors: Hiroshi Kunii, Wako-shi (JP); Akinari Hayashi, Wako-shi (JP); Yusuke Yamamura, Wako-shi (JP)

(21) Appl. No.: 16/796,985

(22) Filed: Feb. 21, 2020

(30) Foreign Application Priority Data
Feb. 26, 2019 (JP) 2019-032950

(51) Int. Cl. H02K 5/22; H01R 13/621; H01R 13/514; H01R 25/16; H01B 5/02; H01B 5/12

(52) U.S. Cl. CPC H02K 5/225; H01R 13/621; H01R 13/514; H01R 2201/26; H01B 5/02; H01B 5/12; H01R 25/16

(57) ABSTRACT

A power feed joint structure includes three module-side bus bars, three motor-side bus bar, three flexible conductive members configured to connect the module-side bus bars and the motor-side bus bars, a bus bar housing configured to hold the three motor-side bus bars, and an insulating cover member configured to restrict falling of the module-side bus bars. The module-side bus bars are connected to each of the internal power feeding passages of a power module, respectively. The motor-side bus bars are connected to each of the external power feeding passages of a motor unit, respectively.

### CROSS-REFERENCE TO RELATED APPLICATION

Priority is claimed on Japanese Patent Application No. 2019-032950, filed Feb. 26, 2019, the content of which is incorporated herein by reference.

### BACKGROUND OF THE INVENTION

### Field of the Invention

The present invention relates to a power feed joint structure of a power control unit connected to a motor unit.

### Description of Related Art

A configuration in which a power control unit is directly connected to a block of a motor unit (hereinafter referred to as a “motor block”) mounted in a vehicle is known. A power module including a function of an inverter, a boosting converter, or the like configured to drive and regenerate a motor is installed in the power control unit. A power feed joint configured to connect power feeding passages of three phases on the side of the motor block and power feeding passages of three phases on the side of the power module is provided between the motor block and the power control unit.

As a structure of such as a power feed joint, a configuration in which three bus bars connected to the power feeding passage on the side of the motor block protrude from the motor block, and tip portions of the bus bars are connected to the power feeding passage corresponding to the power module through bolt fastening or the like in the power control unit is known.

However, in the case of the structure of the power feed joint, since the bus bar is a rigid body, in order to absorb manufacturing errors or assembling errors of parts related to bolt fastening or avoid stress concentration on the bus bar due to traveling vibrations, the bus bar needs to be longer than a certain length. For this reason, it was not possible to avoid an increase in size of the power feed joint.

In addition, as a structure of another power feed joint, a structure in which a braided wire that can be easily bent and deformed is used in a part of a power feed joint is known (for example, see Japanese Unexamined Patent Application, First Publication No. 2016-139540).

In the structure of the power feed joint, the manufacturing errors or the assembling errors of the parts can be absorbed by deformation of the braided wire, and the stress concentration due to the traveling vibrations can also be avoided by the braided wire that can be easily deformed.

### SUMMARY OF THE INVENTION

However, when the braided wire is used in the power feed joint, and the motor-side bus bar and the module-side bus bar are simply connected by the braided wire, if a module-side bus bar is connected to the power feeding passage of the power module in the power control unit while the motor-side bus bar is connected to the motor block, the module-side bus bar easily falls down due to deformation of the braided wire. For this reason, connecting work of the module-side bus bar to the power feeding passage of the power module becomes difficult.

An aspect of the present invention is directed to providing a power feed joint structure of a power control unit capable of connecting a module-side bus bar to an internal power feeding passage of a power module in a stable posture while employing a configuration in which a motor-side bus bar and the module-side bus bar are connected by a flexible conductive member.

A power feed joint structure of a power control unit according to the present invention employs the following configuration in order to solve the above-mentioned problems.

(1) A power feed joint structure of a power control unit according to the present invention is a power feed joint structure of a power control unit configured to connect internal power feeding passages of three phases of a power module and external power feeding passages of three phases of a motor unit, the power feed joint structure of the power control unit including: three module-side bus bars connected to each of the internal power feeding passages, respectively; three motor-side bus bars connected to each of the external power feeding passages, respectively; three flexible conductive members configured to connect the module-side bus bars and the motor-side bus bars, which have corresponding phases; a bus bar housing attached to a fixed block and configured to hold the three motor-side bus bars; and an insulating cover member configured to restrict falling of the module-side bus bars by using the flexible conductive members.

According to the configuration of the above-mentioned (1), since the motor-side bus bars and the module-side bus bars of the respective phases are connected via the flexible conductive members, adjustment of relative positions between the motor-side bus bars and the module-side bus bars of the corresponding phases can be easily performed by deforming the flexible conductive members. In addition, when traveling vibrations or the like are transmitted, occurrence of stress concentration on the bus bars can be minimized by deforming the flexible conductive members. Accordingly, a length from one end portion of the motor-side bus bar to the other end portion of the module-side bus bar can be reduced, and reduction in size of the power feed joint can be achieved. In addition, since falling of the module-side bus bars due to the flexible conductive members is restricted by the insulating cover member, in a state in which the bus bar housing is attached to the fixed block, when the module-side bus bars are connected to the internal power feeding passages of the power module, the module-side bus bars can be maintained in a stable posture. Accordingly, according to this configuration, the module-side bus bars can be easily connected to the internal power feeding passages of the power module. Further, since falling of the module-side bus bars is restricted by the insulating cover member, even when the module-side bus bars or the flexible conductive members come into contact with the insulating cover member, occurrence of short circuit between peripheral members can be prevented.

(2) In the aspect of the above-mentioned (1), the insulating cover member may have a partition wall configured to partition the neighboring flexible conductive members.

In this case, since the neighboring flexible conductive members are partitioned by the insulating partition wall, the neighboring flexible conductive members can be more closely disposed without causing short circuit of current.

Accordingly, when this configuration is employed, reduction in size of the power feed joint can be achieved.

(3) In the aspect of the above-mentioned (2), the insulating cover member may be formed in a shape that surrounds the flexible conductive members with a gap.

In this case, regardless of the direction in which the flexible conductive members are deformed, falling of the module-side bus bars can be restricted by the insulating cover member.

(4) In the aspect of any one of the above-mentioned (1) to (3), the insulating cover member may extend to a position facing the module-side bus bars.

In this case, when the module-side bus bars deform the flexible conductive members and fall down, the module-side bus bars abut the insulating cover member. For this reason, falling of the module-side bus bars can be reliably restricted.

(5) In the aspect of any one of the above-mentioned (1) to (4), the insulating cover member may be detachably attached to the bus bar housing.

In this case, the insulating cover member can be reliably supported by the bus bar housing, and the insulating cover member can be easily removed upon maintenance.

(6) In the aspect of any one of the above-mentioned (1) to (5), concave sections configured to separate enclosing sections of the neighboring module-side bus bars may be provided in edges of the insulating cover member disposed closer to the power module, and displacement restricting sections, which are inserted into the concave sections and which are configured to restrict displacement of the insulating cover member, may be provided so as to protrude from a block disposed closer to the power module.

In this case, when the displacement restricting section disposed closer to the side of the power module is inserted into the concave section of the insulating cover member, since displacement of the insulating cover member is restricted by the displacement restricting protrusion, the module-side bus bars can be positioned on the block disposed closer to the side of the power module through the insulating cover member. For this reason, when each of the module-side bus bars are connected to the internal power feeding passages of the power module, connecting work thereof becomes easy. In addition, when the module-side bus bars are connected to the internal power feeding passages by screw or the like, rotation of the module-side bus bars due to the screw can be restricted by the displacement restricting section.

Further, when the insulating cover member is attached to the bus bar housing from the side closer to the power module through fitting or the like, removal of the insulating cover member from the bus bar housing can be restricted by the displacement restricting section.

(7) In the aspect of any one of the above-mentioned (1) to (6), the flexible conductive member may be constituted by a braided wire.

In this case, the motor-side bus bars and the module-side bus bars are connected by the braided wire to be relatively displaceable in various directions. In addition, heat generated in the braided wire, a joint thereof, or the like can be efficiently radiated to the outside from a surface portion of the braided wire having a large surface area.

In the aspect of the present invention, since the motor-side bus bars and the module-side bus bars are connected via the flexible conductive members, a manufacturing error or an assembling error of each part can be absorbed by the flexible conductive member, and the external power feeding passages and the internal power feeding passages of the power module can be reliably connected. In addition, during transmission of traveling vibrations or the like, since the flexible conductive member is bent, occurrence of stress concentration on the bus bar can be minimized Here, in the aspect of the present invention, since a length of the bus bar can be reduced to an extent that the flexible conductive member can be interposed, reduction in size of the power feed joint can be achieved.

Further, in the aspect of the present invention, since falling of the module-side bus bars due to the flexible conductive members can be restricted by the insulating cover member, when the module-side bus bars are connected to the internal power feeding passages of the power module, the module-side bus bars can be maintained in a stable posture. Accordingly, according to the aspect of the present invention, connecting work of the module-side bus bars to the internal power feeding passages of the power module can be easily performed.

### BRIEF DESCRIPTION OF THE DRAWINGS

FIG. 1 is a plan view showing disposition of devices in an engine compartment of a vehicle of an embodiment.

FIG. 2 is a schematic side view of the vehicle of the embodiment corresponding to an arrow II in FIG. 1.

FIG. 3 is a side view of a power control unit of the embodiment.

FIG. 4 is a side view of an upper section of a motor block of the embodiment.

FIG. 5 is a front view of a power feed connecting module of the embodiment.

FIG. 6 is an exploded perspective view of the power feed connecting module of the embodiment.

FIG. 7 is a cross-sectional view of the power control unit of the embodiment along line VII-VII in FIG. 3.

FIG. 8 is a cross-sectional view of the power control unit of the embodiment along line VIII-VIII in FIG. 7.

FIG. 9 is a plan view of a water jacket of the embodiment.

FIG. 10 is a perspective view of the power control unit of the embodiment in the engine compartment.

### DETAILED DESCRIPTION OF THE INVENTION

Hereinafter, an embodiment of the present invention will be described with reference to the accompanying drawings. Further, in some of the drawings, an arrow FR indicates a forward direction with respect to a vehicle, an arrow UP indicates an upward direction with respect to the vehicle, and an arrow LH indicates a leftward direction with respect to the vehicle.

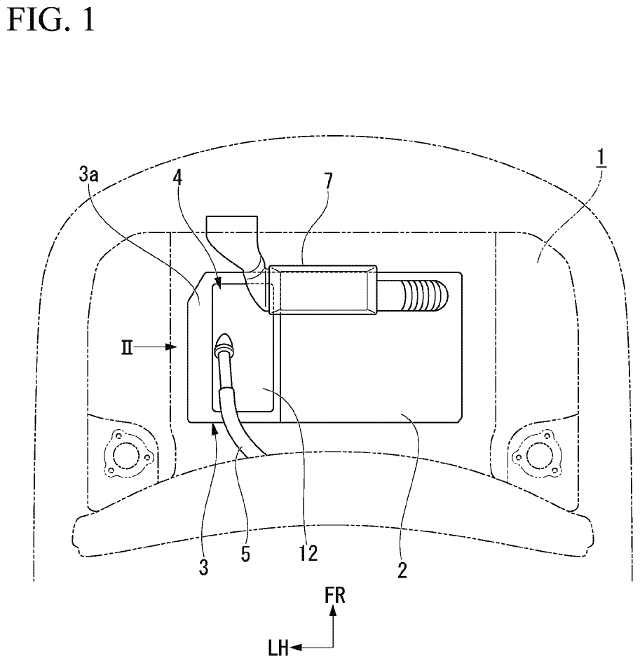

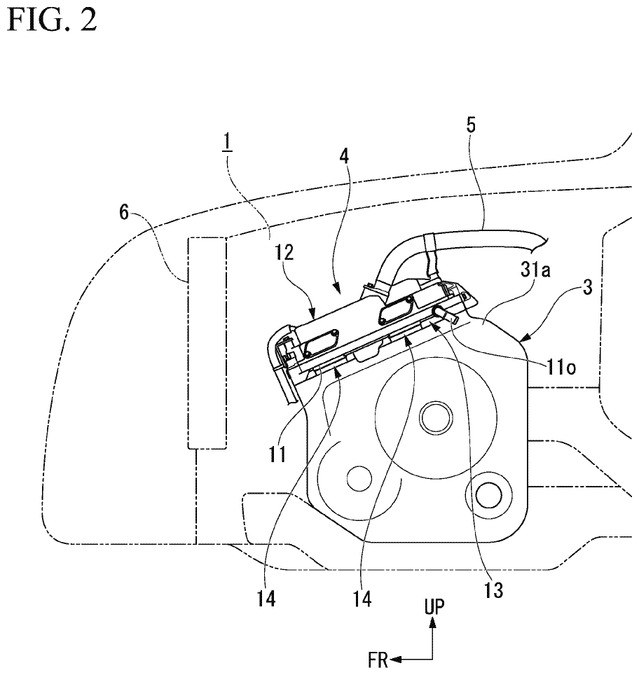

FIG. 1 is a view showing an engine compartment 1 of a vehicle from above, and FIG. 2 is a schematic side view corresponding to an arrow II in FIG. 1.

An engine 2 and a motor unit 3 that are configured to drive the vehicle are mounted in the engine compartment 1 of the vehicle. The motor unit 3 performs driving of the vehicle and regenerative power generation according to traveling circumstances of the vehicle. The motor unit 3 is integrally coupled to a side portion of the engine 2. A power control unit 4 configured to convert electric power of a high voltage battery (not shown) into an alternating current and output the converted alternating current to the motor unit 3, and reversely, output the electric power generated as regenerative power in the motor unit 3 to the high voltage battery is connected to an upper section of the motor unit 3. Further, reference numeral 5 in the drawings designates a high voltage cable configured to connect the high voltage battery (not shown) and the power control unit 4, reference numeral 6 designates a radiator, and reference numeral 7 designates an air cleaner configured to filter external air and introduce the external air into the engine 2.

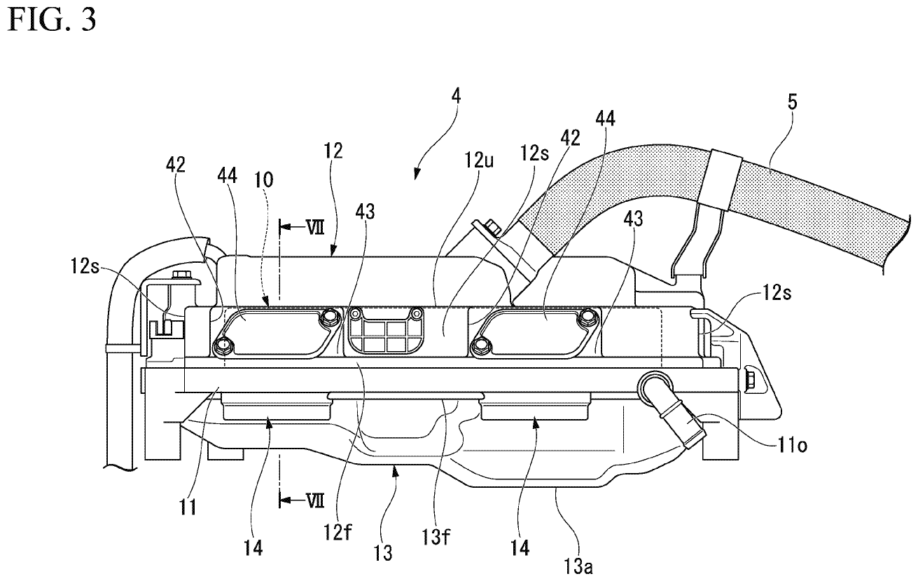

FIG. 3 is a view showing the power control unit 4 from a leftward side of the vehicle.

The power control unit 4 includes a power module 10 having a function of an inverter, a boosting converter, or the like, a water jacket 11 disposed below the power module 10 and configured to support the power module 10, an upper case 12 attached to an upper surface side of the water jacket 11 and configured to cover the top and periphery of the power module 10, and a lower case 13 attached to a lower surface side of the water jacket 11 and configured to cover a reactor or the like (not shown) disposed below the water jacket 11.

The power module 10 receives a control signal from a control device (not shown), converts direct current of the high voltage battery into a three-phase alternating current and outputs the alternating current to a motor main body section of the motor unit 3, and converts the three-phase alternating current generated by the motor main body section into a direct current and outputs the converted direct current to the high voltage battery during regenerative power generation. The power module 10 and the motor unit 3 are electrically connected by two power feed connecting modules 14 (power feed joints). The two power feed connecting modules 14 are a power feed connecting module configured to drive a motor and a power feed connecting module for regeneration. The two power feed connecting modules 14 have the same configuration. The two power feed connecting modules 14 are attached to an upper section of a motor block 3a (a fixed block) of the motor unit 3 and separated from each other in a vehicle forward/rearward direction. The power feed connecting modules 14 are detachably attached to the upper section of the motor block 3a.

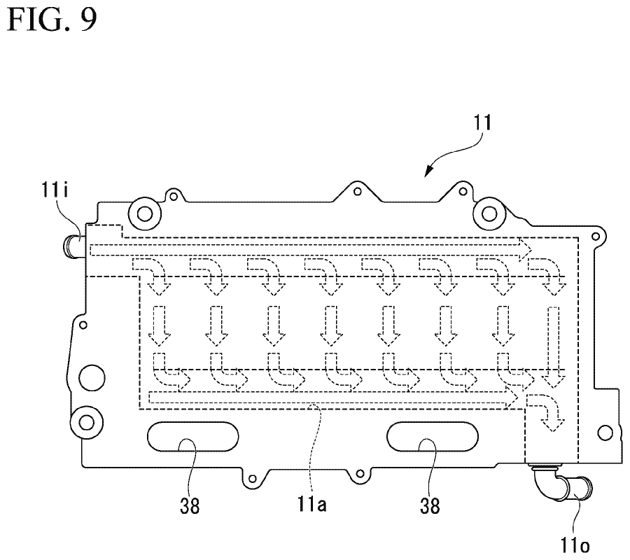

The water jacket 11 is formed of a metal material having good thermal conductivity, and cools mounted devices as cooling water circulates therethrough. An introduction port 11i and a discharge port 11o (see FIG. 9) for cooling water are provided in the water jacket 11. The introduction port 11i and the discharge port 11o are connected to a cooling water circulation circuit (not shown).

In addition, the power module 10 is attached to an upper surface side of the water jacket 11 via a module holding member 17. In the embodiment, the module holding member 17 and the water jacket 11 constitute a support block configured to support the power module 10 at a lower side of the power module 10.

The upper case 12 has major parts that are integrally formed of an aluminum alloy, a heat-resisting resin, or the like. The upper case 12 has an upper wall 12u configured to mainly cover the power module 10 from above, sidewalls 12s extending to be bent from front, rear, left and right end portions of the upper wall 12u in a direction of the water jacket 11, and circumferential edge flanges 12f overhanging outward from lower ends of the sidewalls 12s. The circumferential edge flanges 12f overlap the upper surface of the water jacket 11, and are fastened to a circumferential edge portion of the water jacket 11 by bolts.

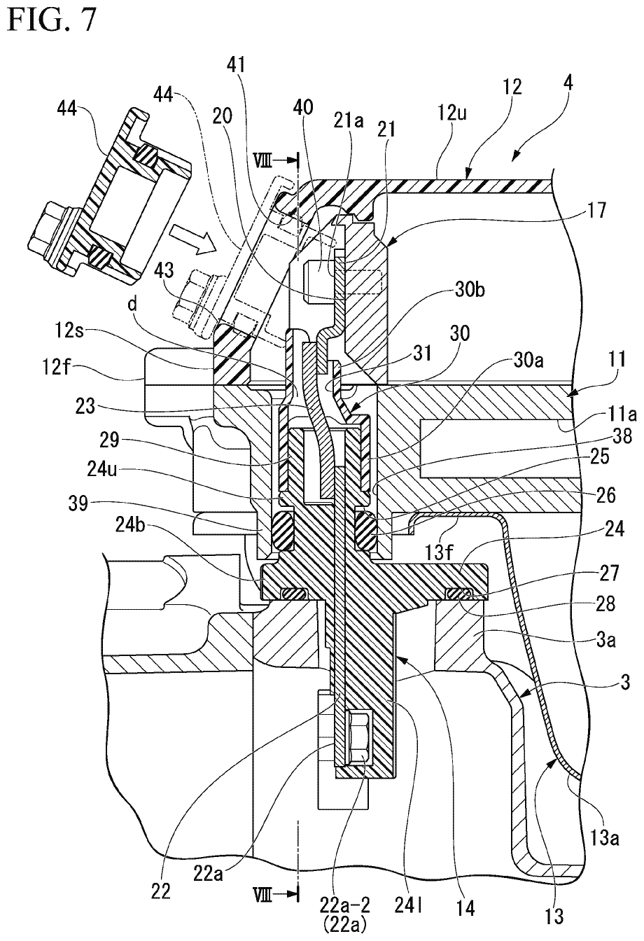

The lower case 13 is integrally formed of a metal plate member. The lower case 13 has a circumferential edge flange 13f (see FIG. 7) fastened to a lower surface of the water jacket 11 by bolts, and a swelling section 13a swelling downward from the circumferential edge flange 13f. The swelling section 13a covers outer sides of accommodated parts such as a reactor and the like (not shown) attached to the lower surface side of the water jacket 11.

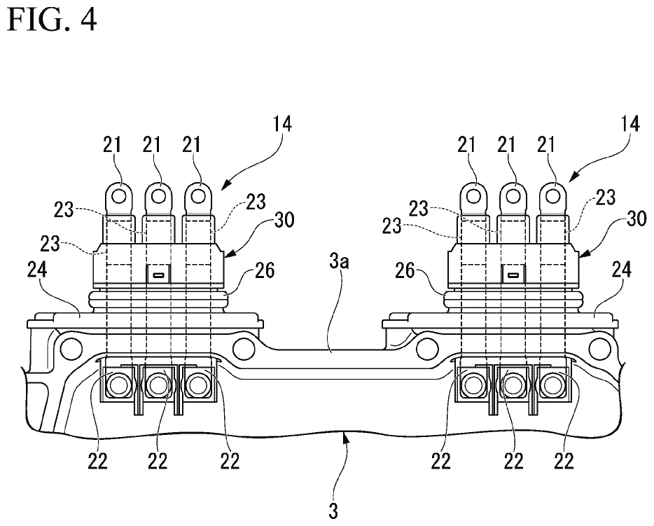

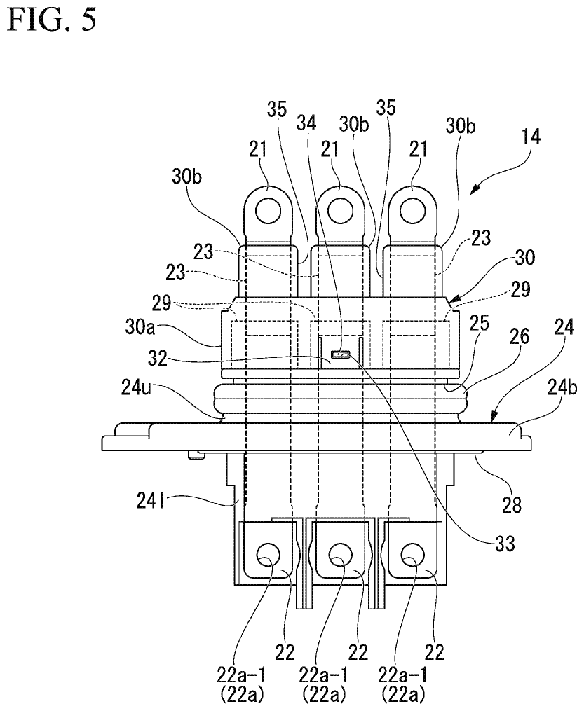

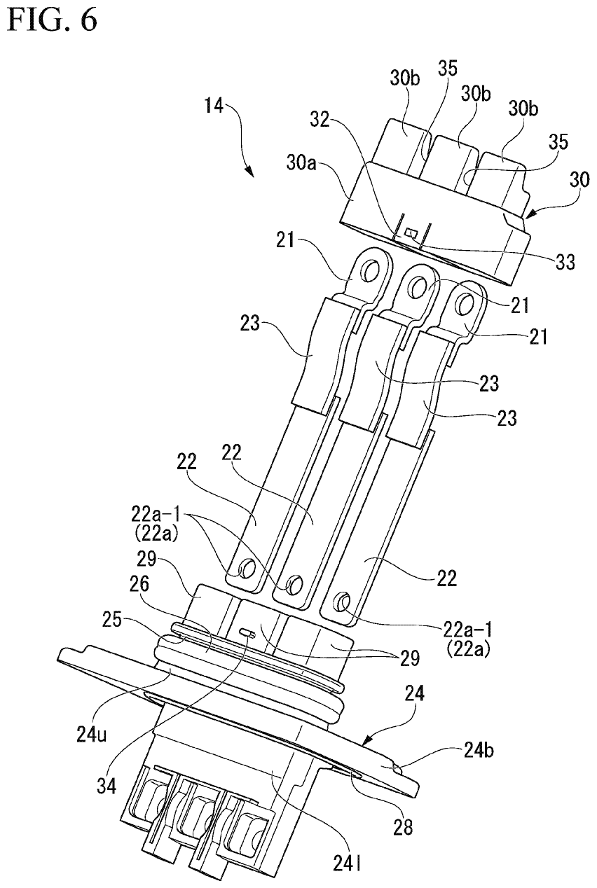

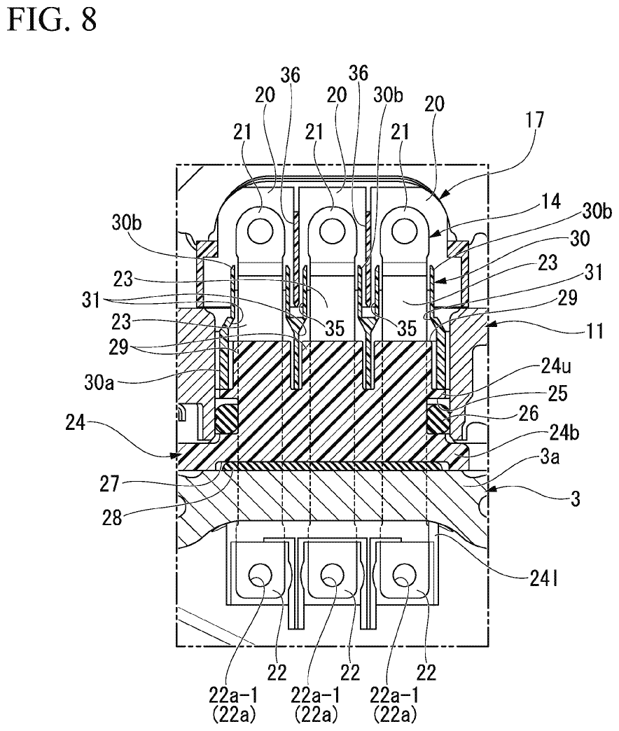

FIG. 4 is a view showing a state in which the two power feed connecting modules 14 are attached to the upper section of the motor block 3a. FIG. 5 is a front view of the power feed connecting modules 14, and FIG. 6 is an exploded perspective view of the power feed connecting modules 14. In addition, FIG. 7 is a cross-sectional view along line VII-VII in FIG. 3, and FIG. 8 is a cross-sectional view along line VIII-VIII in FIG. 7. Further, the two power feed connecting modules 14 are connected to the inside of the power control unit 4 substantially similarly. In addition, a structure of a joint in the power control unit 4 corresponding to each of the power feed connecting modules 14 is also similar thereto.

As shown in FIG. 7 and FIG. 8, internal power feeding passages 20 connected to each of the power feed connecting modules 14 are provided in the module holding member 17 that holds the power module 10. Three internal power feeding passages 20 are provided to correspond to each of the power feed connecting modules 14. In addition, three external power feeding passages (not shown) are also provided to correspond to each of the power feed connecting modules 14 similarly on the side of the motor block 3a of the motor unit 3.

As shown in FIG. 4 and FIG. 5, each of the power feed connecting modules 14 includes three module-side bus bars 21 connected to the internal power feeding passages 20 on the side of the power module 10, three motor-side bus bars 22 connected to an external power feeding passage on the side of the motor unit 3, three flexible conductive members 23 configured to connect the module-side bus bars 21 and the motor-side bus bars 22, which have corresponding phases, and a bus bar housing 24 (a conductive housing) formed of an insulating resin and configured to hold the three motor-side bus bars 22.

The module-side bus bars 21 and the motor-side bus bars 22 are formed of a conductive metal plate having a predetermined thickness.

For example, the flexible conductive members 23 are constituted by braided wires obtained by braiding a plurality of copper wires. Further, the flexible conductive member 23 is not limited to the braided wire and may be another member as long as the member is a deformable conductive member. However, when the braided wire is employed, the module-side bus bars 21 and the motor-side bus bars 22 can be easily deformed in various directions, and heat generated due to electric conduction is easily radiated to the outside.

In the embodiment, three of the module-side bus bars 21, the flexible conductive members 23 and the motor-side bus bars 22 constitute a connection conductor configured to connect the internal power feeding passages 20 on the side of the power module 10 and the external power feeding passage on the side of the motor unit 3.

As shown in FIG. 5 and FIG. 6, the bus bar housing 24 has a plate-shaped base wall 24b overlapping and fastened to an upper surface (see FIG. 4) of the motor block 3a by bolts, a downward protruding section 241 protruding downward from the base wall 24b, and an upward protruding section 24u protruding upward from the base wall 24b. The three motor-side bus bars 22 are held on the downward protruding section 241, the base wall 24b and the upward protruding section 24u and are separated from each other. The three motor-side bus bars 22 are held in the bus bar housing 24 such that a lengthwise direction is aligned with an upward/downward direction and they are aligned side by side in a row. In addition, lower end portions of the motor-side bus bars 22 are exposed to the outside from a side surface of the downward protruding section 241 close to a lower end thereof. Connecting fixing sections 22a fastened to the external power feeding passage in the motor unit 3 by bolts are provided on the lower end portions of the motor-side bus bars 22. In the embodiment, the connecting fixing section is constituted by a bolt insertion hole 22a-1 and a weld nut 22a-2.

An annular holding groove 25 having a vertical width larger than a dimension in a depth direction is formed in an outer circumferential surface of the upward protruding section 24u of the bus bar housing 24 on a base end side. A seal ring 26 (a seal member) having a substantially elliptical shape with a vertically elongated cross section is mounted in the holding groove 25. The seal ring 26 seals a gap with the water jacket 11 as will be described below. In addition, an annular groove 27 is formed in a lower surface of the base wall 24b, and a seal ring 28 configured to seal between the lower surface of the base wall 24b and the upper surface of the motor block 3a is mounted in the annular groove 27.

Three tubular sections 29 configured to independently cover the peripheries of upper end sides of the three motor-side bus bars 22 protrude on an upper end side of the upward protruding section 24u of the bus bar housing 24. An integrated insulating cover member 30 formed of an insulating resin material is detachably attached to the three tubular sections 29. Further, the insulating cover member 30 constitutes the power feed connecting modules 14 together with the module-side bus bars 21, the motor-side bus bars 22, the flexible conductive members 23, the bus bar housing 24, and the like.

The insulating cover member 30 includes lower blocks 30a fitted into the three tubular sections 29 of the bus bar housing 24 from above, and three cylinder sections 30b protruding upward from upper sections of the lower blocks 30a. Continuous insertion holes 31 that pass in the upward/downward direction are formed in the lower blocks 30a and the cylinder sections 30b. Lower ends of the insertion holes 31 disposed in the lower blocks 30a are fitted into the tubular sections 29 of the bus bar housing 24. The flexible conductive members 23 having corresponding phases and parts of the module-side bus bars 21 on the lower section side are disposed in the cylinder sections 30b and inserted therethrough.

As shown in FIG. 7, when the insulating cover member 30 is assembled to the upper section of the bus bar housing 24, surroundings of joints of the upper sections of the motor-side bus bars 22 of the phases and the flexible conductive members 23 are directly covered with the tubular sections 29 of the bus bar housing 24. In addition, at this time, surroundings of the joints of the flexible conductive members 23 of each phases and the lower sections of the module-side bus bars 21 are directly covered with circumferential walls of the corresponding insertion holes 31 of the insulating cover member 30. Accordingly, the lower section sides of the flexible conductive members 23 are covered with the insulating cover member 30 with the tubular sections 29 of the bus bar housing 24 sandwiched therebetween, and the upper section sides of the flexible conductive members 23 are directly covered with the insulating cover member 30. As shown in FIG. 7, the insulating cover member 30 and the tubular sections 29 surround peripheries of the flexible conductive members 23 or the module-side bus bars 21 with a gap d.

Further, in the embodiment, walls of the cylinder sections 30b of the insulating cover member 30 constitute partition walls that partition the adjacent flexible conductive members 23.

The cylinder sections 30b of the insulating cover member 30 attached to the bus bar housing 24 have upper end portions that extend to positions facing at least parts of the module-side bus bars 21. For this reason, the insulating cover member 30 can reliably restrict falling of the module-side bus bars 21 due to deformation of the flexible conductive members 23 using the cylinder sections 30b.

However, the insulating cover member 30 can restrict falling of the module-side bus bars 21 to somewhat extent as long as it is a structure that surrounds peripheries of the flexible conductive members 23 even at heights that do not reach positions facing the module-side bus bars 21.

In addition, as shown in FIG. 6 or the like, tongues 32 that are flexibly deformable by notches are formed on walls of lower edges of the lower blocks 30a of the insulating cover member 30. Locking holes 33 are formed in the tongues 32 to pass therethrough in a plate thickness direction. On the other hand, protrusions 34 that can be fitted into the locking holes 33 are provided on outer surfaces of the tubular sections 29 of the bus bar housing 24. The protrusions 34 bend the tongues 32 and are fitted into the locking holes 33 when the insulating cover member 30 is fitted into the tubular sections 29 of the bus bar housing 24. Accordingly, the insulating cover member 30 is retained in the bus bar housing 24.

In addition, as shown in FIG. 5 and FIG. 8, the insulating cover member 30 of the embodiment forms a concave section 35 in which upper surfaces of the neighboring cylinder sections 30b and the lower blocks 30a are open upward.

The concave section 35 is configured to separate the enclosing sections of the neighboring module-side bus bars 21 and to which a displacement restricting section 36 protruding from the module holding member 17 is inserted therein when the power feed connecting modules 14 are assembled to the power control unit 4. The displacement restricting section 36 restricts displacement of the insulating cover member 30 by being inserted into the concave section 35 of the insulating cover member 30.

FIG. 9 is a view showing the water jacket 11 from above.

The water jacket 11 is formed in a substantially rectangular shape when seen in a plan view, the introduction port 11i for the cooling water is disposed in a front surface close to one end in a lengthwise direction, and the discharge port 11o for the cooling water is disposed in a side surface close to the other end in the lengthwise direction. A cooling passage 11a through which the cooling water flows toward the discharge port 11o from the introduction port 11i is formed in the water jacket 11. A pair of through-holes 38 passing through the water jacket 11 from an upward side to a downward side are formed at positions close to the cooling passage 11a of one side portion of the water jacket 11. The through-holes 38 are formed in elongated hole shapes in a lengthwise direction of the water jacket 11.

In addition, as shown in FIG. 7, tubular walls 39 protruding downward protrude from lower edge portions of the through-holes 38 of the water jacket 11. Inner circumferential surfaces of the tubular walls 39 are continuous with the through-holes 38. Parts of the power feed connecting modules 14 are inserted into the tubular walls 39 and the through-holes 38 from below. Specifically, a portion of the bus bar housing 24 above the base wall 24b, the insulating cover member 30 assembled to the bus bar housing 24, and upper regions of the three-phase connection conductors (the module-side bus bars 21, the flexible conductive members 23 and the motor-side bus bars 22) held therein are inserted into the tubular walls 39 and the through-holes 38. Here, the seal ring 26 attached to the upward protruding section 24u of the bus bar housing 24 becomes in close contact with the inner circumferential surfaces of the tubular walls 39 while being elastically deformed. The seal ring 26 abuts the inner circumferential surfaces of the tubular walls 39 and the inner wall of the holding groove 25 of the upward protruding section 24u and closes a space therebetween. As a result, surroundings of the water jacket 11 below the through-holes 38 are closed by the seal ring 26. The seal ring 26 transfers heat toward a main body section of the water jacket 11 through the tubular walls 39. For this reason, the heat transmitted to the seal ring 26 from the three-phase connection conductor is radiated to the water jacket 11.

Further, the base wall 24b of the bus bar housing 24 is fixed to the lower surface of the water jacket 11 through bolt fastening or the like. In addition, the flexible conductive members 23 having the phases are disposed on portions inside the through-holes 38.

As described above, when the parts of the power feed connecting modules 14 are inserted into the tubular walls 39 and the through-holes 38, falling of the module-side bus bars 21 due to bending of the flexible conductive members 23 is restricted by the insulating cover member 30. In addition, as described above, when the power feed connecting modules 14 are assembled to the water jacket 11, connecting fixing sections 21a of upper ends of the module-side bus bars 21 of the power feed connecting modules 14 are disposed at positions facing the internal power feeding passages 20 corresponding to the module holding member 17. As shown in FIG. 7, the connecting fixing sections 21a of the module-side bus bars 21 are connected to the corresponding internal power feeding passages 20 through fastening using bolts 40.

Fastening of the connecting fixing sections 21a by the bolts 40 (fastening members) is performed by an operating tool through opening sections 41 provided in the upper case 12. The opening sections 41 are disposed at positions in the upper case 12 facing the connecting fixing sections 21a of the module-side bus bars 21 from diagonally above the side portions.

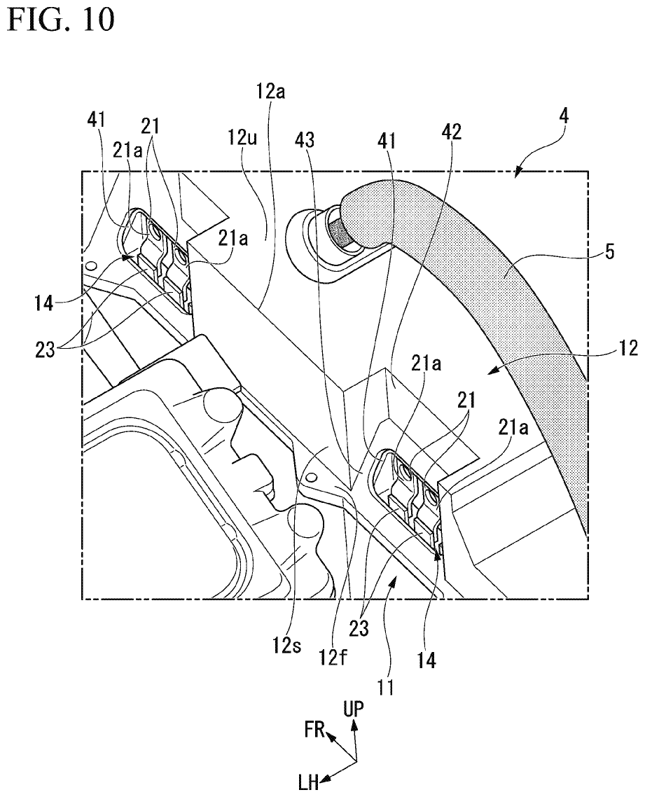

FIG. 10 is a view showing the power control unit 4 disposed in the engine compartment 1 from diagonally above and to the left of a rear section thereof.

As shown in FIG. 10, two concave sections 42 are formed in lateral side 12a of the upper case 12, which is sandwiched between the upper wall 12u and the sidewall 12s (the sidewall facing outward in the vehicle width direction) of the upper case 12 and which has a substantially perpendicular cross-sectional shape such that corner sections of the lateral sides 12a are cut out. Bottom walls of the concave sections 42 are constituted by inclined walls 43 inclined downward from a central side of the upper wall 12u in a direction of the sidewalls 12s. The opening sections 41 used upon fastening or the like of the connecting fixing sections 21a are formed in the inclined walls 43. The inclined walls 43 are formed at positions facing the connecting fixing sections 21a from diagonally above the side portions thereof.

The opening sections 41 are formed to have a shape and a size such that head sections of the bolts 40 that are fastening members or the connecting fixing sections 21a are visually recognizable when seen in a front view perpendicular to the inclined walls 43. In addition, since the opening sections 41 are provided to perform an attachment/detachment operation of the bolts 40 that are fastening members, the opening sections 41 are formed to have a size such that the bolts 40 or a tip portion of the operating tool can be inserted thereinto.

In addition, as shown in FIG. 7, since the through-holes 38 of the water jacket 11 are disposed below the opening sections 41 of the upper case 12, falling of the bolts 40 from the through-holes 38 upon attachment/detachment of the bolts 40 needs to be avoided. In the embodiment, since the insulating cover member 30 are disposed to fill gaps between the through-holes 38 and the connection conductor (the module-side bus bar 21 or the flexible conductive members 23), dropping of the bolts 40 from the through-holes 38 can be prevented.

In addition, as shown in FIG. 7, the opening sections 41 provided in the inclined walls 43 are normally closed by a lid member 44. The lid member 44 is detachably attached to the corresponding inclined wall 43 by a screw clamp or the like, and removed from the inclined wall 43 upon necessity such as maintenance or the like.

In addition, as shown in FIG. 10, a high voltage cable 5 connected to a high voltage circuit including a capacitor in the upper case 12 is extracted from the upper section of the upper case 12. The high voltage cable 5 is routed at positions that avoid the inclined walls 43 on the upper wall 12u of the upper case 12.

As described above, in the power feed joint structure of the power control unit of the embodiment, the motor-side bus bars 22 of the phases of the power feed connecting modules 14 and the module-side bus bars 21 are connected to each other via the flexible conductive members 23. For this reason, adjustment of relative positions between the motor-side bus bars 22 and the module-side bus bars 21 of the corresponding phases can be easily performed by deformation of the flexible conductive members 23. Accordingly, even when there is a manufacturing error or an assembly error in the power feed connecting modules 14 or the joint thereof, an error extent thereof can be absorbed by deformation of the flexible conductive members 23. In addition, since the flexible conductive members 23 are softly bent upon transmission of traveling vibrations or the like, occurrence of stress concentration on the bus bar can be minimized. Further, in the power feed joint structure of the embodiment, in comparison with the case in which an elongated bus bar having a connecting fixing section on a motor side and a joint on a module side at both ends is used, a length of the power feed connecting modules 14 in the upward/downward direction can be reduced.

In addition, in the power feed joint structure of the embodiment, since falling of the module-side bus bars 21 due to the flexible conductive members 23 can be restricted by the insulating cover member 30, the module-side bus bars 21 can be maintained in a stable posture upon assembly of the power control unit 4. Accordingly, when the power feed joint structure of the embodiment is employed, a connecting work of the module-side bus bars 21 to the internal power feeding passages 20 of the power module 10 can be easily performed.

In addition, in the power feed joint structure of the embodiment, the insulating cover member 30 has the cylinder sections 30b and functions as a partition wall that partitions the flexible conductive members 23 adjacent to the cylinder sections 30b. For this reason, the neighboring flexible conductive members can be brought closer to each other without causing a short circuit of the current. Accordingly, when the configuration is employed, reduction in size of the power feed joint can be achieved.

In addition, in the power feed joint structure of the embodiment, the insulating cover member 30 has the gap d so as to surround the flexible conductive members 23. For this reason, regardless of the direction in which the flexible conductive members 23 are bent, falling of the module-side bus bars 21 can be reliably restricted by the insulating cover member 30.

Further, in the power feed joint structure of the embodiment, since the insulating cover member 30 extends upward to the position facing the module-side bus bars 21, when the module-side bus bars 21 fall according to bending of the flexible conductive members 23, the insulating cover member 30 reliably abuts the module-side bus bars 21. Accordingly, when the configuration is employed, falling of the module-side bus bar upon assembly can be reliably restricted, and workability can be further improved.

In addition, in the power feed joint structure of the embodiment, since the insulating cover member 30 is detachably attached to the bus bar housing 24, the insulating cover member 30 can be reliably supported by the bus bar housing 24, and further, the insulating cover member 30 can be easily removed upon maintenance.

In addition, in the power feed joint structure of the embodiment, the concave sections 35 configured to separate the enclosing sections of the neighboring module-side bus bars 21 are provided in the upper section of the insulating cover member 30 (an edge on the side of the power module 10), and the displacement restricting sections 36 inserted into the concave sections 35 protrude from the module holding member 17 on the side of the power module 10. For this reason, when the connecting fixing sections 21a of the three module-side bus bars 21 are connected to the internal power feeding passages 20, the connecting fixing sections 21a of the module-side bus bars 21 can be positioned at the module holding member 17 through the insulating cover member 30 by engaging the concave sections 35 and the displacement restricting section 36 with each other. Accordingly, when the configuration is employed, a connecting work of the module-side bus bars 21 to the internal power feeding passages 20 becomes easy.

Further, when the module-side bus bars 21 are connected to the internal power feeding passages 20 through fastening by the bolts 40, co-rotation of the module-side bus bars 21 according to fastening of the bolts 40 is restricted by the displacement restricting section 36. For this reason, fastening workability of the bolts 40 also becomes better.

In addition, in the power feed joint structure of the embodiment, since the displacement restricting section 36 provided so as to protrude from the module holding member 17 is disposed in the concave section 35 of the insulating cover member 30, when the insulating cover member 30 moves upward from the bus bar housing 24 so as to be removed, removal of the insulating cover member 30 can be restricted by the displacement restricting section 36. Accordingly, when the configuration is employed, the insulating cover member 30 can be stably maintained at a predetermined position.

In addition, as exemplified in the description of the embodiment, when the braided wire is employed as the flexible conductive members 23 configured to connect the module-side bus bars 21 and the motor-side bus bars 22, the heat generated from the braided wire, the joint, or the like, can be efficiently radiated to the outside from a surface portion of the braided wire having a large surface area while the motor-side bus bars 22 and the module-side bus bars 21 can be easily relatively displaced in various directions.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A power feed joint structure of a power control unit configured to connect internal power feeding passages of three phases of a power module and external power feeding passages of three phases of a motor unit, the power feed joint structure of the power control unit comprising:
three module-side bus bars connected to each of the internal power feeding passages, respectively;
three motor-side bus bars connected to each of the external power feeding passages, respectively;
three flexible conductive members configured to connect the module-side bus bars and the motor-side bus bars, which have corresponding phases;
a bus bar housing attached to a fixed block and configured to hold the three motor-side bus bars; and
an insulating cover member configured to restrict falling of the module-side bus bars by using the flexible conductive members.

2. The power feed joint structure of the power control unit according to claim 1, wherein the insulating cover member has a partition wall configured to partition the neighboring flexible conductive members.

3. The power feed joint structure of the power control unit according to claim 2, wherein the insulating cover member is formed in a shape that surrounds the flexible conductive members with a gap.

4. The power feed joint structure of the power control unit according to claim 1, wherein the insulating cover member extends to a position facing the module-side bus bars.

5. The power feed joint structure of the power control unit according to claim 1, wherein the insulating cover member is detachably attached to the bus bar housing.

6. The power feed joint structure of the power control unit according to claim 1, wherein concave sections configured to separate enclosing sections of the neighboring module-side bus bars are provided in edges of the insulating cover member disposed closer to the power module, and
displacement restricting sections, which are inserted into the concave sections and which are configured to restrict displacement of the insulating cover member, is provided so as to protrude from a block disposed closer to the power module.

7. The power feed joint structure of the power control unit according to claim 1, wherein the flexible conductive member is constituted by a braided wire.
